(19) United States
(12) Patent Application Publication
(10) Pub. No.: US 2020/0166068 A1
(43) Pub. Date: May 28, 2020

(54) TORQUE LIMITING NUT AND APPLICATION THEREOF

(71) Applicant: VAF Industries, LLC, Escondido, CA (US)

(72) Inventors: Glenn Sailer, Escondido, CA (US); Raymond Tai, San Marcos, CA (US)

(73) Assignee: VAF Industries, LLC, Escondido, CA (US)

(21) Appl. No.: 16/200,552

(22) Filed: Nov. 26, 2018

(51) Int. Cl. F16B 31/02

(52) U.S. Cl. CPC F16B 31/021

(57) ABSTRACT

A torque-limiting nut and a method of securing a bolted joint by using the same are disclosed. The nut comprises a head having a first hex external side surface and a first internal side surface that is cylindrical and unthreaded, a body formed to have a generally flange shape having a second hex external side surface and a second internal side surface that is cylindrical and threaded, and a plurality of posts, each post contiguously connecting the head and the body. The shapes and dimensions of the parts, including the shape and dimensions of each post, the number of the posts, etc., are determined to have the plurality of posts sheared off from the body when a torque applied to the first hex external side surface exceeds a predetermined amount.

### BACKGROUND

Bolted joints are used commonly in construction and machine design. A simple form of bolted joint has a bolt that captures and joins other parts, and the combination is secured with a nut by mating the threads. To secure the joint, a certain amount of clamp force must be developed at the joint by tightening by turning/wrenching the nut. The clamp force is generated by the tension generated in the bolt slightly elongated in the direction vertical to the part's surface. The tension strength and the applied torque strength are generally proportional to each other. Thus, theoretically, if you know the diameter of the bolt, the torque needed to tighten the bolt so as to reach the right amount of clamp force/tension can be predetermined. However, the proportional constant (nut factor) depends on the type and material of the bolt and nut; the presence and type of any plating, coating or lubrication; the pitch or angle of the threads; and corrosion and wear, thereby varying even from one time to the next. Too much clamp force may cause warping of the joint or breaking the bolt, and too little may risk a loose, unsecured joint. These joint failures may possibly result in expensive downtime or even accidents. It is thus a challenge for a field operator to determine when enough torque has been applied for generating a right amount of clamp force/tension. Conventionally, a field operator may rely on his/her experience or intuition while turning/wrenching a nut around a bolt, or may use a torque chart which is often inaccurate and cumbersome.

In view of the above problems and ambiguities associated with every-day nuts-and-bolts operations, this document describes a new type of nut, which eliminates the uncertainty as to deciding when enough turning/wrenching has been applied for creating a secured bolted joint.

### BRIEF DESCRIPTION OF THE DRAWINGS

FIGS. 1 and 2 illustrate a top perspective view and a bottom perspective view, respectively, of an example of the torque-limiting nut according to an embodiment.

FIGS. 3 and 4 illustrate a top view and a side view, respectively, of an example of the torque-limiting nut according to an embodiment.

FIG. 5 schematically illustrates how to use the present torque-limiting nut according to an embodiment.

### DETAILED DESCRIPTION

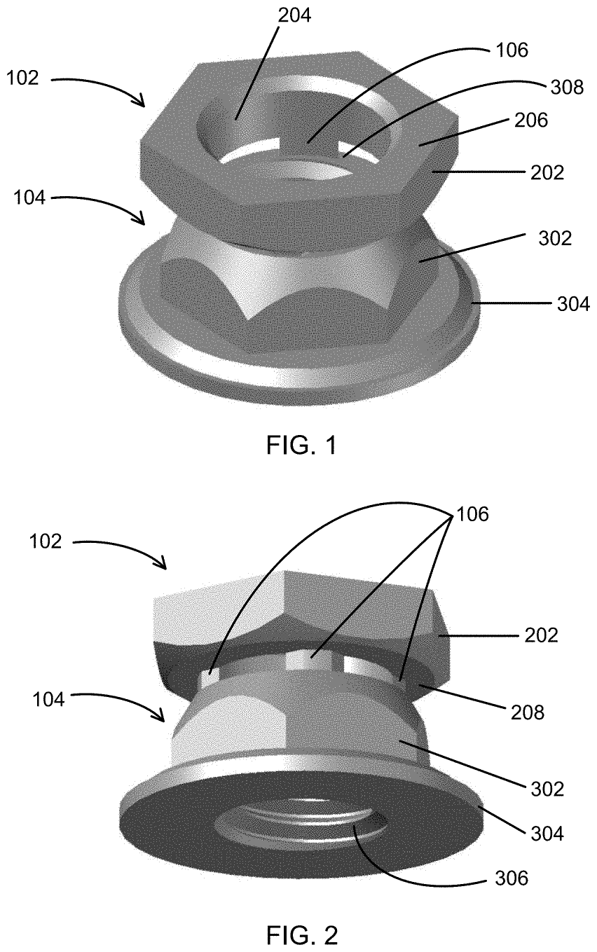

FIGS. 1 and 2 illustrate a top perspective view and a bottom perspective view, respectively, of an example of the torque-limiting nut according to an embodiment. The present torques-limiting nut comprises three sections: a head 102, a body 104 and a plurality of posts 106, each post having two end portions contiguously connected to the head 102 and to the body 104, respectively. The head 102 is formed to be a generally hexagonal prism having a first hex external side surface 202 comprising six flat faces, a first generally cylindrical bore formed along the longitudinal axis therethrough, defining a first internal side surface 204 that is cylindrical and unthreaded, a top surface 206 and a circular bottom portion 208. The body 104 is formed to have a generally flange shape, comprising a neck having a second hex external side surface 302 comprising six flat faces, and a circular collar 304 contiguously connected to the neck, wherein the base diameter of the circular collar 304 is larger than a largest lateral dimension of the neck, A second generally cylindrical bore is formed along the longitudinal axis of the flange-shaped body 104 therethrough, defining a second internal side surface 306 that is cylindrical and threaded.

Each of the plurality of posts 106 is formed longitudinally, having a top end portion contiguously connected to the circular bottom portion 208 of the head 102 and a bottom end portion contiguously connected to the circular top portion 308 of the flange-shaped body 104. The plurality of posts 106 are disposed with an equal distance between adjacent posts. The number of the posts is four in this example; however, the number may be any number of two or more depending on design considerations for target applications.

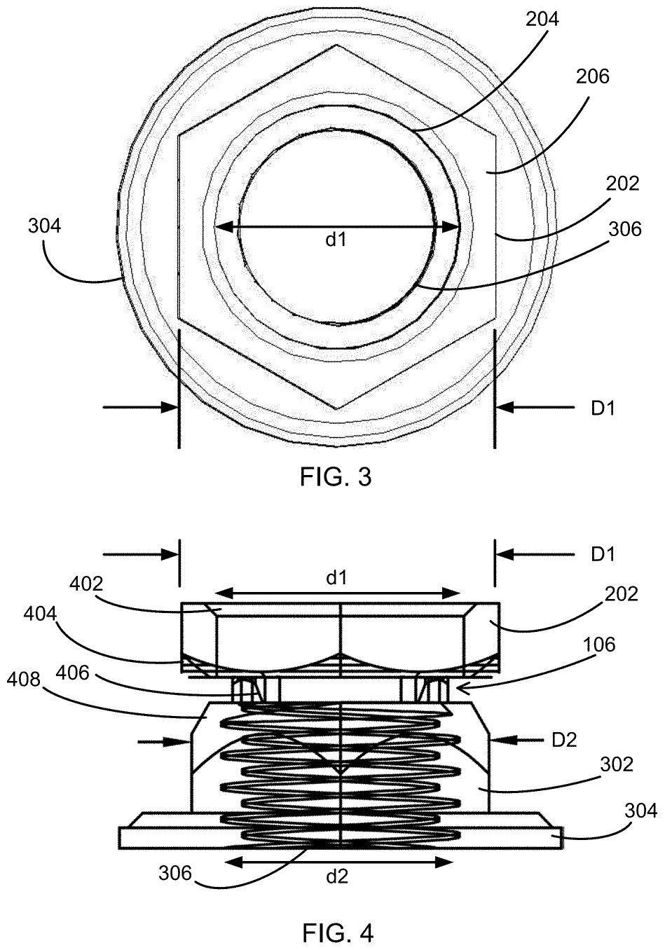

FIGS. 3 and 4 illustrate a top view and a side view, respectively, of an example of the torque-limiting nut according to an embodiment. These figures show a first hex dimension D1, which is the distance between the two opposite flat faces of the first hex external side surface 202, and a second hex dimension D2, which is the distance between the two opposite flat faces of the second hex external side surface 302, where D1 is configured to be larger than D2, i.e., D1>D2. The reason for this configuration will be explained later in this document.

FIGS. 3 and 4 also show a first internal diameter d1 and a second internal diameter d2, wherein d1 is the diameter of the first generally cylindrical bore defined by the first internal side surface 204 that is cylindrical and unthreaded, and d2 is the diameter of the second generally cylindrical bore defined by the second internal side surface 306 that is cylindrical and threaded. Here, d1 is configured to be larger than d2, i.e., d1>d2, so that a bolt inserted through the second generally cylindrical bore of the body 104 can also get through the first generally cylindrical bore of the head 102.

Some of the corners, edges and end portions of the present torque-limiting nut may be tapered or rounded. Some examples are explained with reference to FIG. 4, wherein the head 102 is formed to have a tapered circular inner edge 402 at the corner of the first internal side surface 204 and the top surface 206, and to have a tapered hexagonal edge 404 at the corner of the first hex external side surface 202 and the circular bottom portion 208; and the flange-shaped body 104 is formed to have a tapered circular external edge 408 at the corner of the second hex external side surface 302 and the circular top portion 308. Each of the posts 106 is formed to have the bottom end portion 406 tapered down to contiguously connect to the circular top portion 308 of the flange-shaped body 104, The reason for this tapering will be explained later in this document.

As illustrated in FIGS. 1-4, the base diameter of the circular collar 304 of the flange-shaped body 104 is configured to be larger than the largest lateral dimension of the neck of the body 104, providing a washer effect or support in terms of the strength and stability when secured on another part.

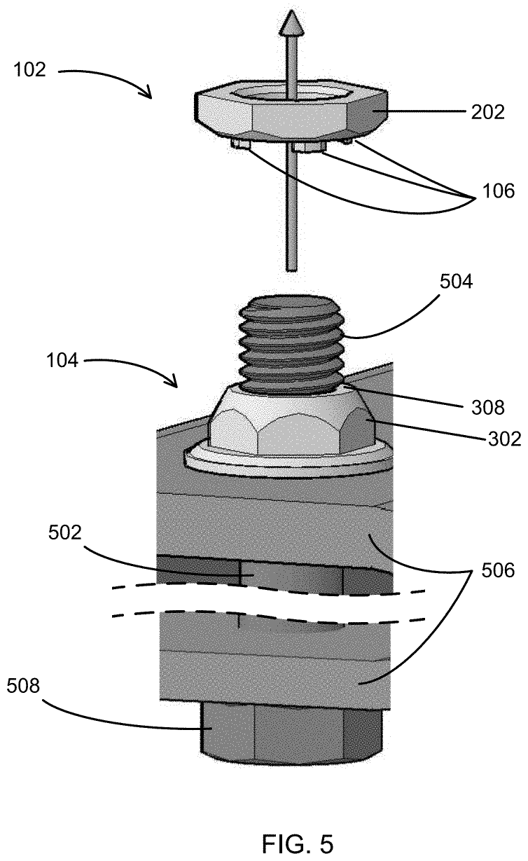

FIG. 5 schematically illustrates how to use the present torque-limiting nut according to an embodiment. First, a bolt 502 having a threaded surface 504 is inserted from one side to the other side of a workpiece 506 through a hole made therein. The other end portion of the bolt 502, i.e., the end portion opposite to the end with the threaded surface 504, is fixed by securing its bolt head 508 with the workpiece 506. Second, to secure the joint, the torque-limiting nut, comprising the head 102, the body 104 and the plurality of posts 106 connected therebetween as illustrated in FIGS. 1-4, is put, with the body 104 first, around the threaded surface 504 of the bolt 502 protruding from the hole of the workpiece 506. Third, the torque-limiting nut is turned around the threaded surface 504 of the bolt 502 by turning/wrenching to engage the threaded surface 504 of the bolt 502 with the second internal side surface 306 that is cylindrical and threaded. A wrench, a spanner, a socket, or other tuning/tightening instrument can be used to apply the wrenching action.

Here, the wrenching action is applied only to the first hex external side surface 202, not to the second hex external side surface 302, because D1>D2. The plurality of posts 106 are configured to break away from the body 104 when the applied torque. i.e., F1×D1, exceeds a predetermined amount of torque, where F1 is the applied force by the wrenching action and D1 is the first hex dimension D1, which is the distance between the two opposite flat faces of the first hex external side surface 202. The predetermined amount of torque is the amount predetermined to be sufficient to fasten the bolt 502, the workpiece 506 and the present torque-limiting nut, in order to form a secured bolted joint. Beyond that point, the plurality of post 106 break away, leaving only the body 104 with the bolted joint. Fine adjustments, such as further tightening or loosening of the remaining nut, i.e., the body 104, can be carried out by wrenching the second hex external side surface 302 that has the second hex dimension D2 which is smaller than D1.

As known to those skilled in the art, to secure a bolted joint, a certain amount of clamp force must be developed at the joint across the workpiece by tightening by turning/wrenching a nut around the bolt. The clamp force is generated by the tension generated in the bolt slightly elongated vertically to the workpiece surface. The tension strength is generally proportional to the applied torque strength. Thus, theoretically, if you know the diameter of the bolt, the torque needed to tighten the bolt so as to reach the right amount of clamp force/tension can be predetermined. However, the proportional constant (nut factor) depends on the type and material of the bolt and nut; the presence and type of any plating, coating or lubrication; the pitch or angle of the threads; and corrosion and wear, thereby varying even from one time to the next. Too much clamp force/tension may cause warping of the joint or breaking the bolt, and too little may risk a loose, unsecured joint. These joint failures may possibly result in expensive downtime or even accidents. It is thus a challenge for a field operator to determine when enough torque has been applied for generating a right amount of clamp force/tension.

Referring to the present torque-limiting nut with the dimensions of D1>D2, while the torque is applied, the relationship F1×D1=F2×D2 holds due to the continuity of the head 102 and the body 104 connected by the plurality of posts 106. Thus, F1<F2 because D1>D2. This means: as F1 is increasingly applied, a threshold torque T(th)=F1(th)×D1=F2(th)×D2 can be reached by providing F1(th) which is less than F2(th). The threshold torque T(th) can be predetermined, on a case-by-case basis, to be the right amount of torque sufficient to tighten the body 104 of the nut to the bolted joint. By interrupting the continuity between the head 102 and the body 104, i.e., by breaking away the head 102 from the body 104, to have F1×D1≠F2×D2, the body 104 can retain the right amount of clamp force/tension, even when the applied force F1 exceeds the threshold force F1(th), i.e., even when the applied torque F1×D1 exceeds the threshold torque T(th)=F1(th)×D1.

In the present torque-limiting nut, the shapes and dimensions of the head 102, the body 104 and the plurality of post 106 are configured such that, when the applied torque F1×D1 exceeds the threshold torque T(th), the posts 106 will shear off, leaving only the body 104 with the bolted joint with the right amount of clamp force/tension. As mentioned earlier with reference to FIG. 4, each of the posts 106 is formed to have a tapered bottom end portion 406 contiguously connected, before the breakaway, to the circular top portion 308 of the flange-shaped body 104. Accordingly, each of the post 106 breaks away at the tapered bottom end portion 406, leaving a substantially clean, smooth surface of the circular top portion 308 of the flange-shaped body 104.

The broken-away head 102 attached with the plurality of posts 106 can be thereafter discarded. Fine adjustments, such as further tightening or loosening of the body 104 of the present torque-limiting nut can be carried out by wrenching the second hex external side surface 302 that has the second hex dimension D2 which is smaller than D1.

The present torque-limiting nut may be made of any durable metal such as stainless steel, aluminum, alloy, etc., and may be formed by use of a Computer Numerical Control (CNC) milling machine that allows for machining parts to precise sizes and shapes, within certain tight tolerances. Based on various calculations and experiments, the present inventors have obtained optimal shapes and dimensions that resulted in proper breaking away of the plurality of posts 106 from the body 104 when the applied torque exceeds the predetermined amount of torque, i.e., the threshold torque T(th). The following are two exemplary dimensions of the present torque-limiting nut. As known to those skilled in the art, these are approximate values and/or within instrumental tolerances or resolutions.

Case 1: the material is low carbon steel with DACROMET® coating, d1 and d2 per ⅝″-11 thread (basic major diameter of ⅝″, 11 threads per inch), D1=1″, D2=⅞″, height=0.77″, base diameter of the circular collar 304=1.3″, the number of posts 106=4, for T(th)=30 ft-lbs.
Case 2: the material is low carbon steel with DACROMET® coating, d1 and d2 per ¾″-10 thread (basic major diameter of ¾″, 10 threads per inch), D1=1″, D2= 15/16″, height=0.77″, base diameter of the circular collar 304=1.38″, the number of posts 106=4, for T(th)=40 ft-lbs.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A nut comprising:
a head formed to be a generally hexagonal prism having a first hex external side surface comprising six flat faces, wherein a first generally cylindrical bore is formed along a longitudinal axis therethrough, defining a first internal side surface that is cylindrical and unthreaded;
a body formed to have a generally flange shape, comprising a neck having a second hex external side surface comprising six flat faces and a circular collar contiguously connected to the neck, wherein a base diameter of the circular collar is larger than a largest lateral dimension of the neck, and wherein a second generally cylindrical bore is formed along the longitudinal axis of the generally flange-shaped body therethrough, defining a second internal side surface that is cylindrical and threaded; and
a plurality of posts, each post having a top end portion and a bottom end portion, the top end portion contiguously connected to a circular bottom portion of the head and the bottom end portion contiguously connected to a circular top portion of the generally flange-shaped body.

2. The nut of claim 1, wherein
a first hex dimension (D1), which is a distance between two opposite flat faces of the first hex external side surface is larger than a second hex dimension (D2), which is a distance between two opposite flat faces of the second hex external side surface.

3. The nut of claim 1, wherein
a first internal diameter (d1), which is a diameter of the first generally cylindrical bore defined by the first internal side surface is larger than a second internal diameter (d2), which is a diameter of the second generally cylindrical bore defined by the second internal side surface.

4. The nut of claim 1, wherein
shapes and dimensions of parts comprised of the nut, including the shape and dimensions of each post, the number of the posts, D1, D2, d1 and d2, are determined to have the plurality of posts sheared off from the body when a torque applied to the first hex external side surface exceeds a predetermined amount while the nut is engaged with a threaded surface of a bolt at a bolted joint.

5. The nut of claim 1, wherein
the bottom end portion of each of the posts is tapered down to contiguously connect to the circular top portion of the flange-shaped body.

6. A method for securing a bolted joint by using the nut of claim 1, the method comprising:
putting the nut with the body first around a threaded surface of a bolt protruding from a hole of a workpiece at the bolted joint;
turning the nut around the threaded surface of the bolt by applying wrenching action to the first hex external side surface to engage the threaded surface of the bolt with the second internal side surface of the nut until the plurality of posts get sheared off from the body of the nut; and
providing fine adjustment by loosening or tightening the body of the nut left with the bolt by providing wrenching action to the second hex external side surface.
